(19) United States
(12) Patent Application Publication
(10) Pub. No.: US 2015/0338024 A1
(43) Pub. Date: Nov. 26, 2015

(54) NOZZLE FOR A PLASTIC CONTAINER AND PLASTIC CONTAINER FOR PRESSURIZED GASES

(71) Applicant: Fibrasynthetica do Brasil Ltda., Bairro Cumbica ( Guarulhos-SP) (BR)

(72) Inventor: Eduardo Kunioki IWATA, São Paulo-SP (BR)

(73) Assignee: Fibrasynthetica do Brasil Ltda., Bairro Cumbica (Guarulhos-SP) (BR)

(21) Appl. No.: 14/759,512

(22) PCT Filed: Jan. 7, 2013
(86) PCT No.: PCT/BR13/00007

§ 371 Date: Jul. 7, 2015

(51) Int. Cl. F17C 1/16; F17C 13/00

(52) U.S. Cl. CPC F17C 1/16; F17C 13/00; F17C 2201/056; F17C 2201/0109; F17C 2203/0617; F17C 2203/066; F17C 2205/0305; F17C 2260/011

(57) ABSTRACT

The container has an end wall portion (12) provided with an access opening (A) in which is affixed a nozzle (B) in the form of a metallic tubular insert (20) comprising: a mounting portion (21) fitted in the access opening (A); a nozzle portion (22); an external peripheral flange (23), having an annular face (23a) in which are adapted annular sealing means (30); and a nut (40) adapted around the mounting portion (21) and pressing the end wall portion (12) against the annular sealing means (30) of the annular face (23a) of the flange (23). The end wall portion (12) may be preformed in a single piece with an annular wall portion or fixed to the latter, and provided, in both constructions, with a median opening (13,51) which defines the access opening (A) of the container.

### FIELD OF THE INVENTION

The present invention refers to a nozzle to be incorporated, as a metallic tubular insert, in a container in the form of a vessel or bottle, having its hollow body constructed in plastic material such as, for example, high density polyethylene, generally having a cylindrical shape and used for storage and transportation of pressurized gases, such as oxygen, natural gas, hydrogen or other gases for domestic, commercial or industrial applications. The invention is also related to a plastic container provided with at least one nozzle, in the form of a metallic tubular insert, for mounting the usual valves for containing and releasing the gas which is stored, generally under pressure, in the interior of the hollow body of the container.

### BACKGROUND OF THE INVENTION

It is known in the art the containers made of single or composite plastic material, and which present, in relation to the metallic containers, several advantages, such as great weight reduction, great resistance to corrosion, to fatigue and to impacts, reduction of the risks of fragmentation of the metallic material in case of rupture, and less vulnerability to cryogenic shocks.

Nevertheless, in some applications, the container requires a metallic nozzle, provided with a thread and being structurally resistant to withstand torsion forces and wear produced by constant operations of connection to flow control valves or to supply and discharge tubings of the gas stored in the container. With the purpose of incorporating the metallic nozzles in said containers of plastic material, the known constructive solutions have proved to be very complex or inadequate to ensure the necessary and reliable tightness between the nozzle, in the form of a metallic tubular insert, and the hollow body of the plastic container, when the pressures in the interior of the latter reach high values, such as, for example, those superior to about 5 kg/cm². Said containers can support higher pressures (above 250 kg/cm²) when they are covered with an adequate and resistant material such as, for example, a composite material (carbon fiber/resin), according to already known techniques. One of said known constructions is disclosed in Brazilian patent PI 9600459-2 (U.S. Pat. No. 5,839,600) of the present applicant. In this prior solution, the tubular metallic insert, which defines the nozzle of the container, comprises, in a single piece, a mounting portion, a nozzle portion and, between them, an external peripheral flange, having an annular face, against which is pressed a connecting ring in plastic material. Onto said plastic connecting ring and around the peripheral flange of the metallic insert is injected a mounting annular portion, also in plastic material, which is fused with the connecting ring, forming a single piece therewith.

The body of the container (or only a part thereof) may be then injected over the nozzle, so as to be fused with the mounting annular portion previously injected over the assembly defined by the metallic tubular insert and by the connecting ring.

While providing a reliable, resistant and tight fixation of a metallic tubular insert in a container body of plastic material, said prior solution requires carrying out an intermediary operation of injecting the mounting annular portion on the insert to which the connecting ring has already been mounted. Such operation increases the complexity of the productive process, as well as the cost of the end product.

Other known constructions are disclosed in U.S. Pat. No. 5,476,189 and WO 2010/080948 A1. In these solutions, the tubular insert has its external peripheral flange configured to allow an adjacent plastic end wall portion of the container to be directly injected on the peripheral flange and affixed thereto, without the aid of any other element for pressing said end wall portion against the flange of the metallic tubular insert.

In said constructions in which the end wall portion of the container is directly locked to the flange of the tubular metallic insert, said flange must be shaped to provide the required retention and sealing degree between the plastic wall and the flange of the metallic tubular insert. Besides requiring especial cares for shaping the peripheral flange and injecting the end wall portion on the flange of the tubular insert, this type of solution presents limitations regarding the pressure level of the gas to be stored and the type of construction applied to the wall that defines the hollow body of the container. In the applications in which a high gas storage pressure is required, the solutions which use, as the only plastic-metal fixation means, the molding and anchorage of the adjacent end wall portion on the peripheral flange, are not adequate for the containers whose hollow body is formed from wall portions defined, usually by injection, in only one plastic material, such as, for example, high density polyethylene.

### SUMMARY OF THE INVENTION

Due to the inconveniences and limitations of the prior art solutions, the present invention has the object to provide a nozzle, in the form of a metallic tubular insert, having a simple and strong construction and which can be easily incorporated, in a tight and reliable way, to a wall portion, which is pre-formed in plastic material, of a container for containing gases kept under high pressures.

The present invention has the further object to provide a plastic container for containing gases under high pressures and which comprises a wall portion, pre-formed in plastic material, and which can be easily affixed, in a tight and reliable way, to a nozzle in the form of a metallic tubular insert.

The nozzle object of the present invention is defined by a metallic tubular insert applied to a plastic container provided with a hollow body for containing a pressurized gas, said hollow body comprising an end wall portion, which is pre-formed in plastic material and provided with an access opening.

According to the invention, the nozzle comprises: a mounting portion fitted through the access opening, projecting to the interior of the hollow body and provided with an external thread; a nozzle portion having a free end in which is provided an internal annular recess with an internal thread extending therefrom; an external peripheral flange, having an annular face seated against the end wall portion, externally to the hollow body and around the access opening; at least one annular sealing means, disposed between the annular face of the external peripheral flange and the end wall portion of the hollow body; and a nut adapted in the external thread of the mounting portion and pressing the end wall portion and the annular sealing means against the annular face of the external peripheral flange.

According to another aspect of the invention, it is provided a plastic container for pressurized gases comprising: a hollow body, having its wall formed in plastic material, impermeable to gas, and including an end wall portion, which may be pre-formed in a single piece with an annular wall portion or fixed to the latter, and which is provided with a median opening which defines the access opening of the container; and a nozzle formed by the metallic tubular insert mentioned above and which is tightly affixed in the access opening.

The construction of the nozzle of the present invention allows the end wall portion, which will be fused to the remaining part of the wall of the hollow body of the container, to be pre-formed, for example, by injection, and affixed to the metallic nozzle, in a reliable and hermetic way, by being pressed against the annular face of the peripheral flange, compressing the sealing means, by simply tightening the nut.

### BRIEF DESCRIPTION OF THE DRAWINGS

The invention will be described below, making reference to the enclosed drawings, given by way of example of possible embodiments of the invention and in which:

FIG. 1 represents an exploded perspective view of the component parts of the nozzle object of the present invention;

FIG. 2 represents a plan view of the nozzle illustrated in FIG. 1;

FIG. 3 represents a diametral sectional view of the nozzle, said section being taken according to line III-III in FIG. 2;

FIG. 4 represents an exploded perspective view of the nozzle of the invention and of an annular wall portion of the container, pre-formed in plastic material;

FIG. 5 represents a diametral sectional view of the nozzle, similar to that of FIG. 3, but with the nozzle already fixed in the access opening of the annular wall portion, which is pre-formed in plastic material and illustrated in FIG. 4;

FIG. 6 represents a diametral longitudinal sectional view of a spheroidal end portion of a cylindrical plastic container, carrying the nozzle illustrated in FIGS. 4 and 5; and

FIG. 7 represents a view similar to that of FIG. 6, but illustrating the nozzle applied to a spheroidal end wall portion, pre-formed in plastic material and already provided with the access opening.

### DESCRIPTION OF THE INVENTION

As already previously mentioned and illustrated in the appended drawings, the nozzle B of the invention is constructed in metallic material, generally steel, to be fixed to a container formed in plastic material, for example high density polyethylene. The container presents a hollow body 10 having a wall 11 formed in plastic material, impermeable to the gas to be stored and including an end wall portion 12 provided with an access opening A, communicating the exterior with the interior of the hollow body 10.

According to the invention, the nozzle B takes the form of a metallic tubular insert 20 which comprises a mounting portion 21, provided with an external thread 21a and which is fitted through the access opening A of the end wall portion 12, so as to project to the interior of the hollow body 10. The metallic tubular insert 20 further incorporates a nozzle portion 22, having a free end 22a projecting to the outside of the hollow body 10, and an external peripheral flange 23, having an annular face 23a, to be seated against the end wall portion 12, externally to the hollow body 10 and around the access opening A. As illustrated in the drawings, the mounting portion 21, the nozzle portion and the external peripheral flange 23 are preferably formed in a single piece.

The metallic tubular insert 20 is further provided with at least one annular sealing means 30, disposed between the annular face 23a of the external peripheral flange 23 and the end wall portion 12 of the hollow body 10. In the illustrated construction, there are provided two annular sealing means 30, concentric to the access opening A, each being defined by a ring in elastomer, which is partially lodged in a respective groove 23c, provided in the annular face 23a of the external peripheral flange 23.

In order to complete the metallic tubular insert 20, it is provided a nut 40, also metallic, to be adapted to the external thread 21a of the mounting portion 21, so as to allow pressing the end wall portion 12 and the annular sealing means 30 against the annular face 23a of the external peripheral flange 23.

According to the preferred form illustrated in the drawings, the nozzle portion 22 of the metallic tubular insert 20 é provided with a thread 22b which is preferably disposed in the interior of the nozzle portion 22 and extending, from an internal annular recess 22c, provided in the free end 22a of the nozzle portion 22, until the region of the metallic tubular insert 20, from which region projects, radially outwardly, the external peripheral flange 23. It should be understood that the thread 22b may be provided externally to the nozzle portion 22, in certain constructive arrangements for coupling the flow control valve (not illustrated) to said nozzle portion 22.

In the illustrated embodiment, the internal annular recess 22c, of the free end 22a of the nozzle portion 22, is dimensioned to house an elastomeric sealing ring (not illustrated), for increasing the tightness degree of the coupling of the control valve in the nozzle B of the container.

In order to facilitate the tightening of the nut 40, against the end wall portion 12 of the hollow body 10 of the container, the nozzle portion 22, of the metallic tubular insert 20, is externally provided with at least two lateral face portions 22d which are parallel and diametrically opposite to each other, for adapting a tool for avoiding the rotation of the metallic tubular insert 20 upon the rotation for tightening the nut 40.

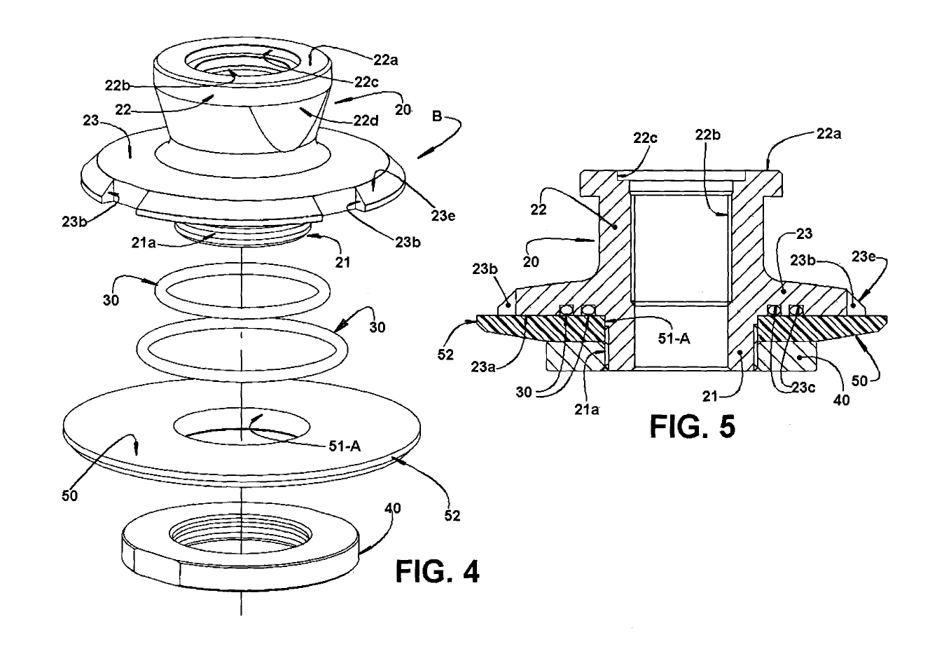

The construction proposed for the nozzle B allows the hollow body 10 of the container to be formed in different manners, as illustrated in FIGS. 4 to 6 and 7.

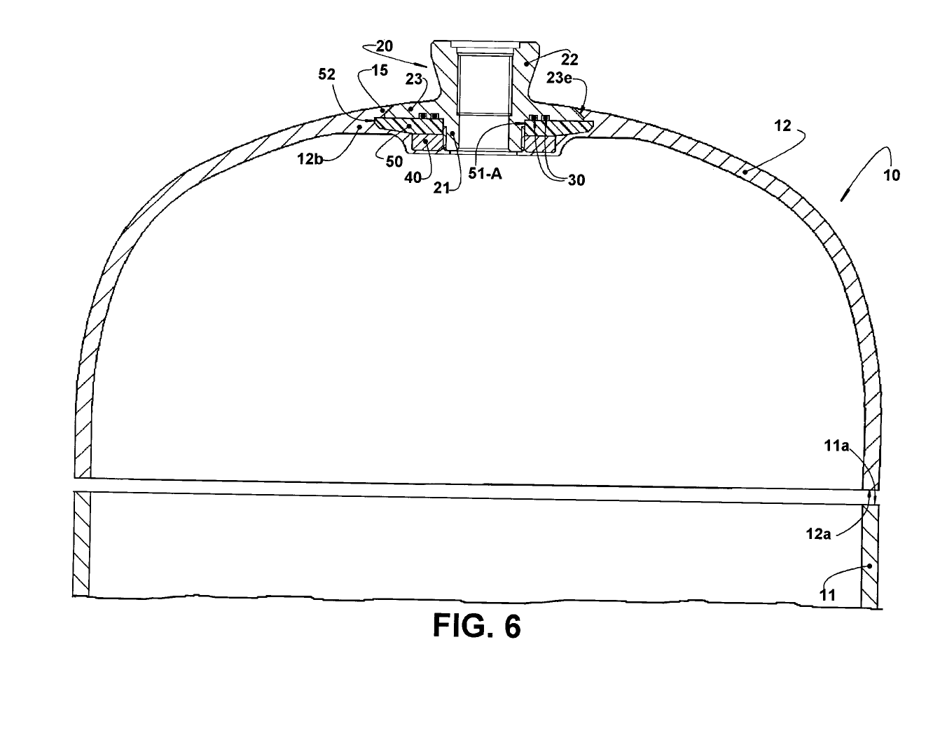

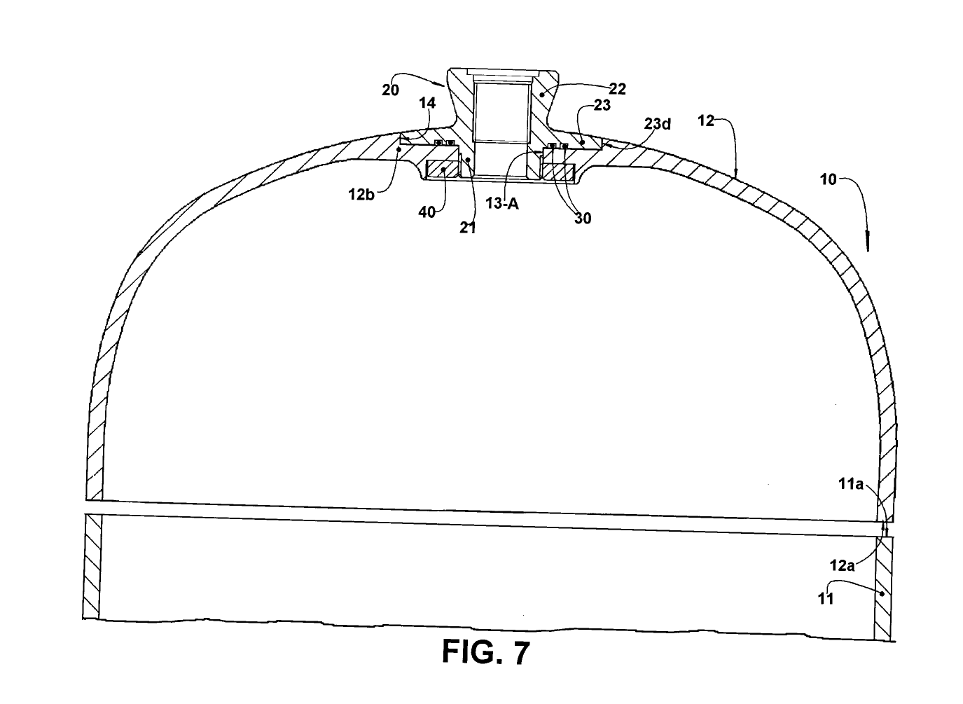

Regardless of the shape of the hollow body 10, the latter may present an end wall 12, in a single piece, having a spheroidal shape, or the form of a flat plate of circular or any polygonal contour, having an outer peripheral edge 12a to be fused with and affixed to an adjacent end edge 11a of the remaining of the wall 11 of the hollow body 10, as indicated in FIGS. 6 and 7. In the illustrated construction, the end wall portion 12 defines an end spheroidal portion of a hollow body 10 presenting a cylindrical tubular shape. In the construction illustrated in FIGS. 4 to 6, the end wall portion 12 incorporates an annular wall portion 50, also in thermoplastic material and provided with a median opening 51 which defines the access opening A of the hollow body 10. In this construction, the annular wall portion 50 is defined as a piece different from that which forms the remaining part of the end wall portion 12 and which has the form of an annular disc, pre-formed in plastic material and to have its median opening 51 trespassed by the mounting portion 21 of the metallic tubular insert 20. Said annular wall portion 50 can be thus pressed by the nut 40, against the annular face 23a of the external peripheral flange 23 and against the annular sealing means 30, guaranteeing the tightness in the interface region of the external peripheral flange 23 with the annular wall portion 50.

As better illustrated in FIGS. 5 and 6, the annular wall portion 50 presents an outer peripheral edge 52 which projects radially outwardly from the external peripheral flange 23.

In such embodiment, in which the annular wall portion 50 is used, the latter is first mounted to the metallic tubular insert 20 and pressed between the nut 40 and the external peripheral flange 23. After affixing the annular wall portion 50 to the metallic tubular insert 20, this assembly may be positioned in a mold (not illustrated), for allowing the end wall portion 12 to be injected in an annular die, with an inner peripheral edge 12b being fused directly to the outer peripheral edge 52 of the annular wall portion 50. Thus, the annular wall portion 50 is incorporated, in a single piece, to the end wall portion 12, as illustrated in FIG. 6. Then, the end wall portion 12, already carrying the annular wall portion 50 and the metallic tubular insert 20, may have its outer peripheral edge 12a fused to the adjacent end edge 11a of the remaining part of the wall 11 of the hollow body 10.

FIG. 7 illustrates an embodiment according to which the end wall portion 12 is pre-formed in a single piece, for example, by injection, presenting a median opening 13 which defines the access opening A of the hollow body 10 and also an outer peripheral edge 12a to be posteriorly fused to an adjacent end edge 11a of the remaining of the wall 11 of the hollow body 10. In this case, before the end wall portion 12 is fused to the remaining of the hollow body 10, the mounting portion 21, of a metallic tubular insert 20, is inserted through the median opening 13 of the end wall portion 12, in order to receive a nut 40. The tightening of said nut presses the confronting region of the end wall portion 12 against the annular sealing means 30 and against the annular face 23a of the external peripheral flange 23, ensuring a solid and tight fixation of the end wall portion 12 to the metallic nozzle B.

Regardless of the fact that the end wall portion 12 is fused, by injection, to an annular wall portion 50, or totally pre-formed by injection, in a single piece, without using the annular wall portion 50, the external peripheral flange 23 has an outer edge provided with a plurality of radial recesses 23b. These radial recesses 23b are at least partially filled with respective parts of the end wall portion 12, ensuring the rotational locking between the nozzle B and the hollow body 10 of the container.

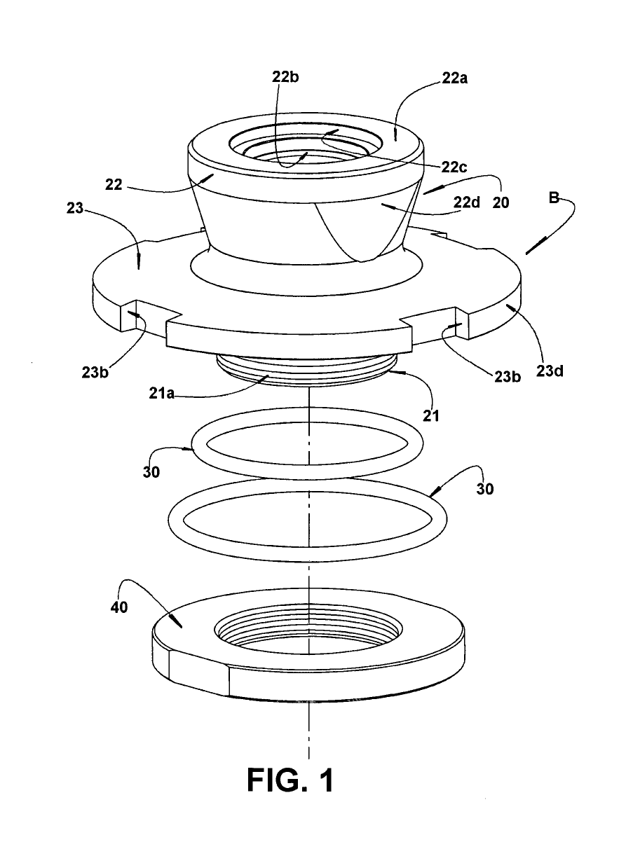

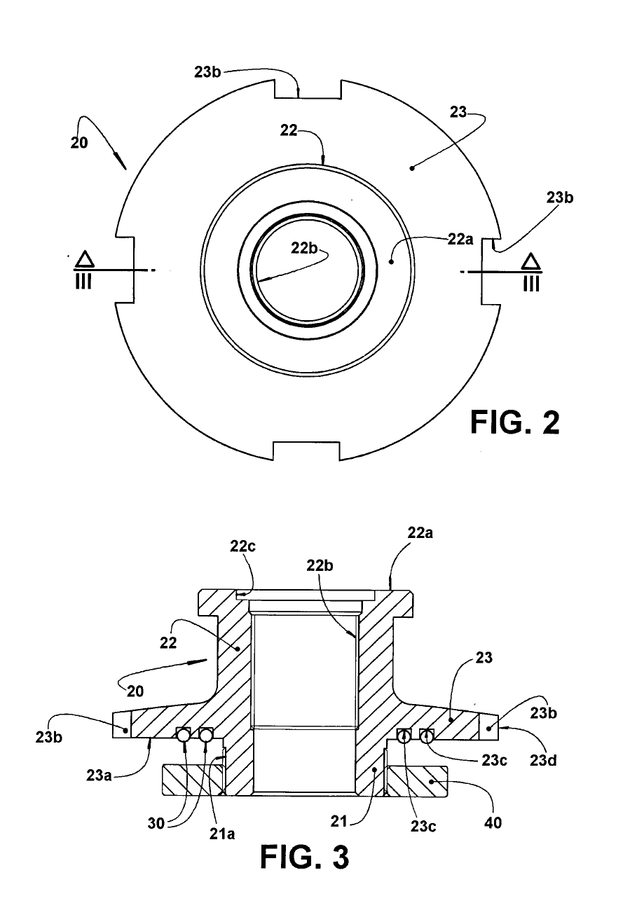

In the embodiment illustrated in FIGS. 1, 2, 3 e 7, the end wall portion 12 is pre-formed by injection, in a single piece, without using the annular wall portion 50. In this case, the external peripheral flange 23 has its outer edge configured in the form of a cylindrical surface 23d, so as to be fitted in a respective recess 14, also cylindrical, externally provided in the end region of the end wall portion 12 defined around the median opening 13 and on which is seated the external peripheral flange 23.

On the other hand, in the embodiment illustrated in FIGS. 4, 5 and 6, the end wall portion 12 is fused, by injection, to the annular wall portion 50. In this case, the external peripheral flange 23 has its external edge superiorly and peripherally chamfered, in order to define a frusto-conical surface 23e, on which may be molded, during the injection phase, a respective end portion 15 of the end wall portion 12, as better illustrated in FIG. 6.

1. A nozzle for a plastic container provided with a hollow body (10) for containing a pressurized gas and which comprises an end wall portion (12), pre-formed in plastic material and provided with an access opening (A), the nozzle (B) being defined by a metallic tubular insert (20) and characterized in that the nozzle comprises:
a mounting portion (21) fitted through the access opening (A), projecting to the interior of the hollow body (10) and provided with an external thread (21a);
a nozzle portion (22) having a free end (22a) in which is provided an internal annular recess (22c), from which extends an internal thread (22b);
an external peripheral flange (23), having an annular face (23a) seated against the end wall portion (12), externally to the hollow body (10) and around the access opening (A);
at least one annular sealing means (30), disposed between the annular face (23a) of the external peripheral flange (23) and the end wall portion (12) of the hollow body (10); and
a nut (40) adapted in the external thread (21a) of the mounting portion (21), pressing the end wall portion (12) and the annular sealing means (30) against the annular face (23a) of the external peripheral flange (23).

2. The nozzle, according to claim 1, wherein the nozzle comprises two annular sealing means (30), in the form of concentric rings in elastomer, which are partially lodged in respective grooves (23c) provided in the annular face (23a) of the external peripheral flange (23).

3. A plastic container for pressurized gases, comprising: a hollow body (10), with its wall (11) formed in plastic material, impermeable to gas, and including an end wall portion (12) provided with an access opening (A); and a nozzle (B) in the form of a metallic tubular insert (20) which is tightly affixed in the access opening (A), the container being characterized in that the metallic tubular insert (20) comprises:
a mounting portion (21) fitted through the access opening (A), projecting to the interior of the hollow body (10) and provided with an external thread (21a);
a nozzle portion (22) having a free end (22a) in which is provided an internal annular recess (22c), from which extends an internal thread (22b);
an external peripheral flange (23), having an annular face (23a) seated against the end wall portion (12), externally to the hollow body (10) and around the access opening (A);
at least one annular sealing means (30), disposed between the annular face (23a) of the external peripheral flange (23) and the end wall portion (12) of the hollow body (10); and
a nut (40) adapted in the external thread (21a) of the mounting portion (21) and pressing the end wall portion (12) and the annular sealing means (30) against the annular face (23a) of the external peripheral flange (23).

4. The container, according to claim 3, wherein the end wall portion (12) is pre-formed in a single piece, presenting a median opening (13) which defines the access opening (A) of the hollow body (10), and also an outer peripheral edge (12a) to be fused to an adjacent end edge (11a) of the remaining of the wall (11) of the hollow body (10).

5. The container, according to claim 3, wherein the end wall portion (12) incorporates an annular wall portion (50), also in thermoplastic material, provided with a median opening (51) which defines the access opening (A) of the hollow body (10), disposed between the external peripheral flange (23) and the nut (40) and having an outer peripheral edge (52) which projects radially outwardly from the external peripheral flange (23), the end wall portion (12) being provided with an inner peripheral edge (12b), to be fused to the outer peripheral edge (52) of the annular wall portion (50), and an outer peripheral edge (12a) to be fused to an adjacent end edge (11a) of the remaining of the wall (11) of the hollow body (10).

6. The container, according to claim 4, wherein the end wall portion (12) defines an end spheroidal portion of a hollow body (10) presenting a cylindrical tubular shape.

7. The container, according to claim 5, wherein the end wall portion (12) defines an end spheroidal portion of a hollow body (10) presenting a cylindrical tubular shape.
